(19) United States
(12) Patent Application Publication
(10) Pub. No.: US 2026/0111688 A1
(43) Pub. Date: Apr. 23, 2026

(54) INFORMATION PROCESSING METHOD, AND INFORMATION PROCESSING DEVICE, AND NON-TRANSITORY COMPUTER-READABLE MEDIUM

(71) Applicant: LegalOn Technologies, Inc., Tokyo (JP)

(72) Inventors: Taizo YAMADA, Tokyo (JP); Rihito ITO, Tokyo (JP); Yugo TERADA, Tokyo (JP); Aya OHATA, Tokyo (JP); Daiki NARUSHIMA, Tokyo (JP)

(21) Appl. No.: 19/425,839

(22) Filed: Dec. 18, 2025

Related U.S. Application Data
(63) Continuation of application No. PCT/JP2024/022231, filed on Jun. 19, 2024.

(30) Foreign Application Priority Data
Jun. 19, 2023 (JP) 2023-100317

(51) Int. Cl. G06F 40/58; G06F 40/166

(52) U.S. Cl. CPC G06F 40/58; G06F 40/166

(57) ABSTRACT

An information processing method according to an embodiment includes: acquiring first document data including a sentence in a first language, and second document data that is a translation of the first document data and includes a sentence in a second language different from the first language; generating risk information data that indicates a risk included in the first document data; and simultaneously displaying the first document data, the second document data, and analysis information of the first document data on a screen of a display device.

### CROSS-REFERENCE TO RELATED APPLICATIONS

This application is a continuation of International Application No. PCT/JP2024/022231, which designates the United States, filed on Jun. 19, 2024. The entire contents of the above applications are incorporated herein by reference.

### TECHNICAL FIELD

Embodiments of the present disclosure relate to an information processing method, an information processing program, and an information processing device.

### BACKGROUND

Conventionally, for example, by using a machine translation tool, a document translated into a language that can be easily created and checked by a user may be created, and presence or absence of a risk portion and a correction proposal may be examined using the document (see Japanese Patent No. 4432810).

### SUMMARY

An information processing method according to an embodiment includes: acquiring first document data including a sentence in a first language, and second document data that is a translation of the first document data and includes a sentence in a second language different from the first language; generating risk information data that indicates a risk included in the first document data; and simultaneously displaying the first document data, the second document data, and analysis information of the first document data on a screen of a display device.

### BRIEF DESCRIPTION OF DRAWINGS

FIG. 1 is a schematic diagram for describing an outline of a document browsing support system according to an embodiment;

FIG. 2 is a block diagram illustrating an example of a hardware configuration of an information processing device according to the embodiment;

FIG. 3 is a diagram illustrating an example of functional blocks in a processor of the information processing device of the present embodiment;

FIG. 4 is a schematic diagram for describing another example of the document browsing support system according to the embodiment;

FIG. 5 is a block diagram illustrating an example of a hardware configuration of a terminal device according to the embodiment;

FIG. 6 is a diagram illustrating an example of functional blocks in a processor of the terminal device according to the embodiment;

FIG. 7 is a diagram illustrating an example of a preview screen displayed on a display device of the terminal device when a multi-language preview support function is executed;

FIG. 8 is a diagram illustrating an example of a support target document in English and a review result displayed on the display device of the terminal device as a result of multi-language review processing;

FIG. 9 is a diagram illustrating an example of a screen displayed on the display device of the terminal device when translation processing is executed in a multi-language review support function;

FIG. 10 is a diagram illustrating an example of a screen displayed on the display device of the terminal device when editing processing (processing of editing a support target document in English using Japanese) using a multi-language editing support function is executed;

FIG. 11 is a diagram illustrating an example of a screen displayed on the display device of the terminal device when editing processing (processing of editing a support target document in English using Japanese) using a multi-language editing support function is executed;

FIG. 12 is a diagram illustrating an example of a screen displayed on the display device of the terminal device when editing processing (processing of editing a support target document in English using English) using a multi-language editing support function is executed;

FIG. 13 is a diagram illustrating an example of output data which is generated by the multi-language editing support function and in which a support target document in English and a support target document in Japanese are associated with each other for each article; and

FIG. 14 is a flowchart illustrating a flow of editing processing using a translation display function according to the present embodiment.

### DESCRIPTION

Hereinafter, an embodiment will be described in detail with reference to the drawings. Note that, in the following description, components having substantially the same functions and configurations are denoted by the same reference numerals, and description thereof will be made if necessary. In addition, the embodiment can be appropriately combined with other embodiments, modifications, and conventional techniques.

A problem to be solved by the present disclosure is to provide an efficient and less burdensome document browsing support technique in a foreign language.

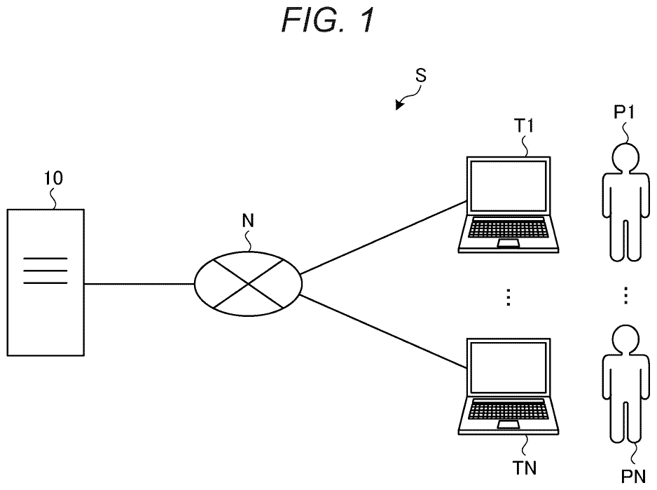

FIG. 1 is a schematic diagram for describing an outline of a document browsing support system S according to the present embodiment. As illustrated in FIG. 1, the document browsing support system S of the present embodiment may function as a support system when a user browses a document, and include, for example, an information processing device 10 according to the embodiment and at least one of terminal devices T1 to TN capable of communicating with the information processing device 10 via a network N. The terminal devices T1 to TN may be operated by users P1 to PN, respectively. Note that the terminal devices T1 to TN will be described by taking a configuration of the terminal device T1 as an example.

Here, the document browsing support system S according to the present embodiment may be, for example, a system that supports browsing (displaying) of a document on a browser. In the present specification, a document may mean a document in any language, created according to a certain rule or standard such as a certain rule, law, or custom. Document data may be document data in any data format. The document data may be typically text data, but can also include data such as image data or tabular data. In addition, the document or the document data can include meta-information (a version, a creation date, an update date, a creator, an updater, and the like), format information (a decoration such as an underline or a marker, a font, indent, and the like), change history information, comment information, and the like created by document creation software.

Hereinafter, in order to make the description specific, a case where a document handled by the document browsing support system S is a legal document (for example, a contract document) in Japanese will be taken as an example. However, the document handled by the document browsing support system S may be, for example, a rule in an organization, and may be, for example, an internal rule in English. In addition, the legal document handled by the document browsing support system S may be described in any language.

The document browsing support system S of the present embodiment may have a translation display function. Here, the translation display function may be a function of implementing document browsing support in another language desired by a user when a document (which may be referred to as a support target document) that is a target of document browsing support is described in a predetermined language. The translation display function can be implemented by at least one of the information processing device 10 and the terminal device T1. In addition, the translation display function can also be implemented by a system different from the document browsing support system S using, for example, an application programming interface (API). Hereinafter, in order to make the description specific, a case where the document browsing support system S has the translation display function will be taken as an example. The translation display function will be described later in detail.

Note that, in the present specification, a document that is a target of document browsing support may also be referred to as an original document. In addition, a language of the original document may be referred to as a “first language”, and another language (different from the first language) selected by a user may be referred to as a “second language”. Hereinafter, in order to make the description specific, a case where the first language is English and the second language is Japanese will be taken as an example.

In addition, the document browsing support system S according to the present embodiment can have a document creation support function in addition to the document browsing support function and the translation display function. Here, the document creation support function may provide a function of editing (modifying, adding, deleting, and the like) a content of a support target document and information for supporting editing. Hereinafter, in order to make the description specific, a case where the document browsing support system S has the document creation support function will be taken as an example. However, it is not essential for the document browsing support system S to have the document creation support function.

A document browsing support service of the present embodiment can include, for example, at least one of: executing document review processing on a support target document on a web browser and providing a result thereof to a user; executing document editing in response to an instruction from the user; storing an edited document or providing the edited document to the user; editing additional information (for example, meta-information, comment information, chat information, or format information) associated with the support target document; creating a new document (including a copy); comparing a plurality of documents (for example, clearly indicating difference information); automatically proofreading the support target document; and executing various types of processing using the translation display function.

In addition, in the present specification, the document review processing may be, for example, processing of analyzing or evaluating information included in a support target document on the basis of a certain standard and outputting a result thereof. For example, the document review processing may include checking and examining whether or not information included in a support target document is appropriate on the basis of a certain standard. Specifically, the document review processing may include, for example, matching between wording in a document and a check list prepared in advance and outputting a result of matching or an indication included in the check list. In addition, editing may mean, for example, adding, deleting, or changing information included in an editing target.

The meta-information associated with the support target document may include, for example, at least one of a document ID, a type of document (for example, a type such a basic transaction contract, a non-disclosure agreement, or a service agreement), a version, a creation date and time, an update date and time, an upload date and time, a creator, an updater, a deadline, and a document ID of a related document.

The comment information associated with the support target document of the present embodiment may be additional information created by at least one user related to creation of the document, and for example, may be associated and managed for each version of the support target document. The comment information associated with the support target document may be a comment created by document creation software.

The chat information of the present embodiment may be, for example, additional information generated by using a chat function for a support target document among a plurality of users related to creation of the support target document, and for example, may be managed in association with a plurality of versions of the support target document. The additional information may be typically text data, but can also include another data format such as an image or voice.

The support target document of the present embodiment may be a document file uploaded from the terminal device, may be a file newly created in the information processing device, for example, by using an online editor, or may be a file already uploaded, stored, and/or edited.

The terminal device T1 of the present embodiment may be a client device managed by the user P1 who uses a document browsing support service. The terminal device T1 may display a document on a screen of a display device, for example, on the basis of information from the information processing device 10. In the present embodiment, using a document review result, an editing screen, a translation display screen, or the like displayed on a screen of a display device of the terminal device T1, a user can perform operations such as indent replacement processing for a support target document, document review reference, comment input, comment reference, chat information input, chat information reference, document editing processing, translation display of the support target document, translation display of the document review, translation display of difference information, translation display of a suggested draft, translation display of an indicated matter, and document storage.

Next, specific configurations of the information processing device 10 and the terminal device T1 of the present embodiment will be described.

### Information Processing Device 10

The information processing device 10 of the present embodiment may be a device that is connected to a client device by communication and performs various types of processing in response to a request from the client device. The information processing device 10 may be, for example, a server device managed by a business operator side that provides a document browsing support service. For example, the information processing device 10 may provide a document browsing support service to the terminal device T1 in response to a document browsing support request received from the terminal device T1 as a client device via the network N. In particular, the information processing device 10 of the present embodiment may execute preview processing, document review processing, document editing processing, and the like using the translation display function in the document browsing support service.

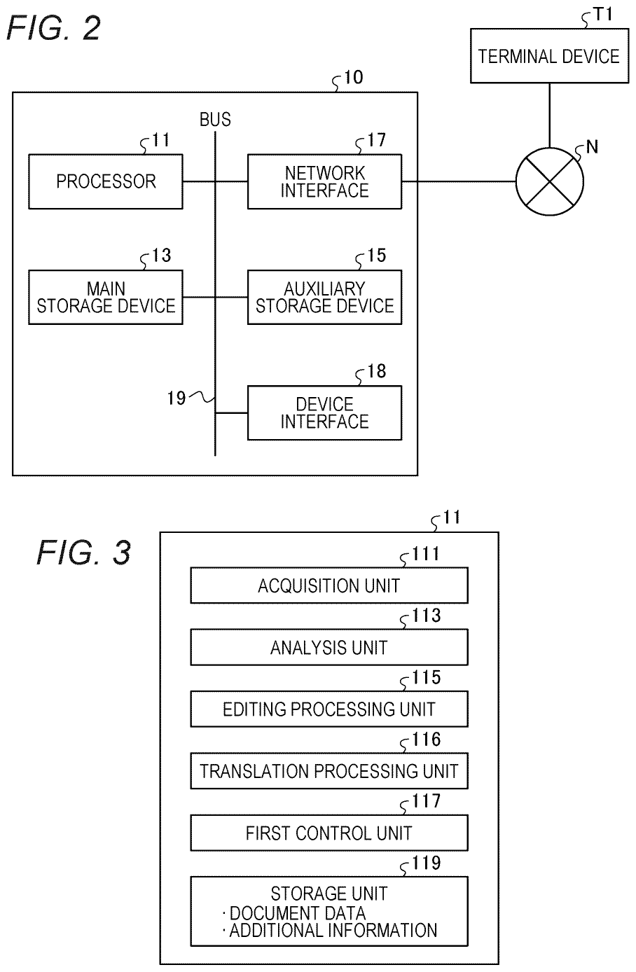

FIG. 2 is a block diagram illustrating an example of a hardware configuration of the information processing device 10 according to the embodiment. As illustrated in FIG. 2, the information processing device 10 of the present embodiment may be a computer, and include, as an example, a processor 11, a main storage device (memory) 13, an auxiliary storage device (memory) 15, a network interface 17, a device interface 18, and a bus 19 that connects the components to each other.

The information processing device 10 of the present embodiment illustrated in FIG. 2 includes each one component, but may include a plurality of the same components. In addition, one information processing device 10 is illustrated in FIG. 2, but software may be installed in a plurality of computers, and each of the plurality of computers may execute the same part or different parts of processing of the software. In this case, the information processing device 10 may be in a form of distributed computing in which each of the computers communicates via the network interface 17 or the like to execute processing. That is, the information processing device 10 in the present embodiment may be configured as a system that implements various functions described later by one or a plurality of computers executing commands stored in one or a plurality of storage devices.

Various computations of the information processing device 10 of the present embodiment may be executed in parallel processing using one or a plurality of processors or using a plurality of computers via a network. In addition, various computations may be distributed to a plurality of computing cores in the processor and executed in parallel processing. In addition, a part or the whole of the processing, means, and the like of the present disclosure may be executed by at least one of a processor and a storage device provided on a cloud capable of communicating with the information processing device 10 via a network. As described above, the processing of the document browsing support system S in the present embodiment may be in a form of parallel computing by one or a plurality of computers.

The processor 11 may be an electronic circuit (a processing circuit, a processing circuitry, a central processing unit (CPU), a graphics processing unit (GPU), a field programmable gate array (FPGA), an application specific integrated circuit (ASIC), or the like) including a control device and a computing device of the information processing device 10. In addition, the processor 11 may be a semiconductor device or the like including a dedicated processing circuit. The processor 11 may be achieved by an optical circuit using an optical logic element without being limited to an electronic circuit using an electronic logic element. In addition, the processor 11 may have a computing function based on quantum computing.

The processor 11 can perform computing processing on the basis of data and software (program) input from each device or the like of an internal configuration of the information processing device 10, and can output a computation result and a control signal to each device or the like. The processor 11 may control each component constituting the information processing device 10 by executing an operating system (OS) of the information processing device 10, an application, or the like.

The information processing device 10 in the present embodiment may be achieved by one or a plurality of processors 11. Here, the processor 11 may refer to one or a plurality of electronic circuits disposed on one chip, or may refer to one or a plurality of electronic circuits disposed on two or more chips or two or more devices. When a plurality of electronic circuits are used, the electronic circuits may communicate in a wired or wireless manner.

The main storage device 13 of the present embodiment may be a storage device that stores commands executed by the processor 11, various types of data, and the like, and information stored in the main storage device 13 is read by the processor 11. The auxiliary storage device 15 may be a storage device other than the main storage device 13. Note that each of these storage devices may mean any electronic component capable of storing electronic information, and may be a semiconductor memory. The semiconductor memory may be either a volatile memory or a nonvolatile memory. A storage device for storing various types of data used in the information processing device 10 according to the present embodiment may be achieved by the main storage device 13 or the auxiliary storage device 15, or may be achieved by a built-in memory built in the processor 11. For example, a storage unit in the present embodiment may be achieved by the main storage device 13 or the auxiliary storage device 15.

To one storage device (memory), a plurality of processors may be connected (coupled), or a single processor 11 may be connected. A plurality of storage devices (memories) may be connected (coupled) to one processor. When the information processing device 10 in the present embodiment includes at least one storage device (memory) and a plurality of processors connected (coupled) to the at least one storage device (memory), at least one processor among the plurality of processors may be connected (coupled) to the at least one storage device (memory). In addition, this configuration may be achieved by storage devices (memories) and the processors 11 included in a plurality of computers. Furthermore, a storage device (memory) may be integrated with the processor 11 (for example, a cache memory including an L1 cache and an L2 cache).

The network interface 17 of the present embodiment may be an interface for connecting to the network N in a wireless or wired manner. As the network interface 17, it may be required to use an appropriate interface such as one conforming to an existing communication standard. The network interface 17 may exchange information with an external device connected via the network N. Note that the network N may be any of a wide area network (WAN), a local area network (LAN), a personal area network (PAN), and the like, or may be a combination thereof, and need to be one that allows exchange of information between the information processing device 10 and an external device. Examples of the WAN may include the Internet, examples of the LAN include IEEE802.11 and Ethernet (registered trademark), and examples of the PAN may include Bluetooth (registered trademark) and near field communication (NFC).

The device interface 18 of the present embodiment may be an interface such as a universal serial bus (USB) directly connected to an output device such as a display device, an input device, and an external device. In addition, the external device may be a storage such as a storage device (memory), a network storage, or an HDD. In addition, the external device may be a device having some functions of components of the information processing device 10 in the present embodiment. That is, the information processing device 10 may transmit or receive a part or the whole of a processing result of the external device.

FIG. 3 is a diagram illustrating an example of functional blocks of the present embodiment in the processor 11. The processor 11 may include, for example, an acquisition unit 111, an analysis unit 113, an editing processing unit 115, a translation processing unit 116, a first control unit 117, and a first storage unit 119 as functions implemented by the processor 11. Functions implemented by the analysis unit 113, the editing processing unit 115, the translation processing unit 116, the first control unit 117, and the first storage unit 119 may be stored as programs in, for example, the main storage device 13 or the auxiliary storage device 15. By reading and executing a program stored in the main storage device 13, the auxiliary storage device 15, or the like, the processor 11 can implement functions related to the analysis unit 113, the editing processing unit 115, the translation processing unit 116, the first control unit 117, and the first storage unit 119.

The acquisition unit 111 of the present embodiment may acquire DOCX-format document data (an example of the first document data) as a support target document via the network N. In addition, the acquisition unit 111 may acquire DOCX-format document data stored in the first storage unit 119 as a support target document. In addition, the acquisition unit 111 may acquire DOCX-format document data stored in a storage unit of another device as a support target document via the network N.

For example, the analysis unit 113 of the present embodiment may execute document review processing using document data of a support target document (an example of the first document data) received from the acquisition unit 111. That is, the analysis unit 113 of the present embodiment may generate document review information described later regarding the document data as the document review processing. Note that the document review information is an example of the analysis information.

In addition, the review information generated by the document review processing executed by the analysis unit 113 of the present embodiment may be based on, for example, information obtained by analyzing a document on the basis of a rule or a standard applied to the document (for example, a certain rule, law, or custom). Examples of review information of a contract document as in the present embodiment may include: (1) an indication as to whether an article included in a document (a contract document in the present embodiment) is advantageous or disadvantageous to a user (party); (2) an advice regarding correction and deletion of the article included in the contract document; (3) an indication that an item that should be usually included in the contract document is missing, and suggestion of an item to be added; and (4) information on the importance and the degree of recommendation of an item of each review result. The (document) review information exemplified in the above (1) to (4) and the like may be referred to as contract review information when the support target document is a contract document. By using the above information, a user can easily perform grasping of a legal risk included in the contract document and contract review response including correction proposal. In addition, format information indicating, for example, whether a format of a sentence meets a standard, and whether a prescribed term is used may also be included. The contract review information is an example of the document review information.

The document review processing executed by the analysis unit 113 may include processing of extracting a risk included in the support target document (risk check processing). Here, the risk check processing may be, for example, to determine, using data of a contract document (hereinafter, also referred to as “risk management target document”) that is a support target for which a contract is agreed among a plurality of contracting parties (a company A and a company B in the case of the present embodiment) and data of a document (hereinafter, also referred to as “reference document”) that is a reference for a contract in one of the contracting parties (a company A in the case of the present embodiment), a risk (residual risk) for one of the contracting parties remaining in the risk management target document, and to present a result thereof to a user. Note that risk information data including the result of the risk check is an example of the document review information or the contract review information.

A risk to be checked by the risk check processing may include, for example, a risk assumed from an article, an expression, and wording that are included in the reference document but are not included in the risk management target document, a risk (hereinafter, also referred to as an “unchecked risk”) assumed from an article, an expression, and wording that are not included in the reference document but are included in the risk management target document, a risk assumed from an article, an expression, and wording that are included in both the reference document and the risk management target document, and a risk assumed due to presence of an article, an expression, and wording that are not included in the reference document or the risk management target document.

Note that the analysis unit 113 may execute the document review processing using the translation display function using a support target document (that is, a support target document in a first language) as an original document. In addition, by setting, the analysis unit 113 can execute the document review processing using the translation display function using a support target document (that is, a support target document in a second language) as a translation.

By performing the document review processing in this manner and displaying a result thereof together with a translation, it is possible to easily match the support target document with a rule or a reference document, and to grasp a risk included in the support target document.

The analysis unit 113 may extract, for example, information that is included in a document (document data) and is necessary for generating review information. Various techniques can be adopted as a method for extracting information from the document data. For example, keyword search of the document data may be performed, and characters, number, and the like included in the vicinity of the keyword may be extracted. In addition, information can also be extracted by morphological analysis, syntax analysis, semantic analysis, or context analysis. Furthermore, information may be extracted by natural language processing using machine learning. In addition, prior to the processing, information necessary for document review, such as text data, may be extracted from received document data, or processing of extracting text data from image data may be performed by processing such as OCR. Note that the document review processing may be performed on the received document without extracting information necessary for generating the document review information as described above.

Note that the generation of the document review information executed by the analysis unit 113 can adopt various techniques. For example, the document review information may be generated on a rule basis using the extracted information. In addition, it is also possible to use a learned model that receives the extracted information as an input and outputs corresponding document review information. Furthermore, it is also possible to adopt a combination of a rule-based method and a learned model. In addition, before the generation of the document review information, the document may be divided into sections, paragraphs, items, and the like in units.

In addition, the analysis unit 113 can generate document review information according to a position of a user (party) by using meta-information associated with the support target document. Furthermore, the analysis unit 113 can also generate the document review information by referring to a content of another document (another version of the support target document, another contract document relevant to the support target document, and the like). The meta-information may include information given to a document file itself of a creator or the like of the document and information given by a user or the like by being input separately from the file.

The editing processing unit 115 of the present embodiment may convert a data format of the support target document (document data) received via the first control unit 117 to generate editing data. For example, the editing processing unit 115 may convert document data of a “DOCX” format file as the support target document received via the acquisition unit 111 from an XML format to a “JSON” format to generate editing data.

In addition, the editing processing unit 115 of the present embodiment may execute editing processing on the editing data in response to an editing instruction received from the terminal device T1 via the acquisition unit 111. Here, the editing processing executed by the editing processing unit 115 may include adding, deleting, and changing information included in the editing data. More specifically, the editing processing may include adding, correcting, and deleting a word, a sentence, and a character decoration (for example, a font, a color of a character, a size of a character, a thickness of a character, an underline, or a strikethrough) with respect to the editing data.

In addition, the editing processing executed by the editing processing unit 115 can include format editing processing, word input assisting processing, draft suggesting processing, indicated matter extraction processing, and difference information extraction processing.

Here, the format editing processing may be, for example, processing of correcting a format of editing data as a document. For example, indent, a line head of itemized writing, right-alignment/left-alignment, deviation of an article number, and the like are preferably automatically corrected with a system by the format editing processing. For example, the editing processing unit 115 may refer to format information of the support target document corresponding to the editing data, and execute format editing processing on the editing data on the basis of the format information.

Setting of a format as a document may be preferably stored in advance in the information processing device 10, a terminal, or the like on the basis of the type of the support target document such as a contract document. For example, in a case of a legal document such as a contract document or an internal rule, setting may be performed such that sections, paragraphs, and items are arranged in this order and in an ascending order of article numbers, and indent is larger in order of sections, paragraphs, and items. In addition, the editing processing unit 115 may execute format editing processing according to a type on the basis of the meta-information of the support target document. Note that this format setting may be created by a user, may be provided as a part of the document browsing support service, or may be created by the user customizing the provided setting. In addition, format setting of the support target document may be interpreted, and may be created on the basis of the interpretation.

The word input assisting processing of the present embodiment may be processing of assisting input, for example, by presenting a candidate word or phrase to be input next at the time of editing document data. As a result, it is possible to support user's input operation at the time of editing and to reduce a workload. For example, a word or the like that frequently appears can be presented as an input candidate according to the type of the support target document. In addition, the support target document stored by a user or an organization to which the user belongs may be analyzed, and a word or the like that is often used may be presented. In addition, a user may set a word or a phrase. The editing processing unit 115 can determine an input candidate word according to a type on the basis of the meta-information of the support target document. A word or the like presented in the input assisting processing may be displayed, for example, in a left window (in a document editing window) of a screen described later.

The draft suggesting processing of the present embodiment may be, for example, processing of displaying a draft of an input candidate at the time of editing. For example, when the document is a contract document, a correction sentence example based on at least a part of a correction content of the contract document may be read from a database in which a provision draft example is accumulated and presented as a draft candidate. As a result, it is possible to support user's input operation at the time of editing and to reduce a workload.

The editing processing unit 115 may present a predetermined draft candidate, may present a draft candidate determined by a user or a provider of the document browsing support service, may present a draft candidate generated by a sentence generation service inside or outside the present system using a large language model (LLM) or the like, or may present a draft candidate frequently appearing according to the type of the support target document. In addition, among drafts included in a document stored by a user or an organization to which the user belongs, a draft that is more frequently used than other drafts or a draft that is highly evaluated by the user, a customer including the user, or the like may be presented as a draft candidate. When there are a plurality of draft candidates, at least one draft candidate can be further selected on the basis of an adoption ratio of a provision (a ratio at which a proposed provision is selected by a user) and an adoption frequency in the past document browsing support service, and a candidate with a higher adoption ratio can be preferentially presented to the user. Note that the draft candidate to be presented can be presented as, for example, the document review information or other information.

The editing processing unit 115 can also edit the editing data in response to the editing instruction based on the presented draft candidate, for example, an instruction by a drag and drop operation. The proposed draft may be displayed in a document review area or the like described later while being associated with a corresponding portion of the document in position. For example, the draft candidate may be displayed close to a corresponding portion of the document. With such display, it is possible to compare the draft candidate and the corresponding portion of the document with less movement of a line of sight, and it is possible to reduce a load on a user.

The indicated matter extraction processing of the present embodiment may be, for example, processing of extracting an indicated matter (for example, document review information, comment information, and chat information about translation document data corresponding to an original document, a correction history for the editing data, or a comment on document data created by a function of document creation software) related to the support target document and presenting the indicated matter to a user. For example, the editing processing unit 115 of the present embodiment may present the extracted indicated matter to a user in a predetermined display form. The indicated matter may be preferably displayed as a list in an area that does not overlap with a portion of the document indicated by the indicated matter, for example, a document review area displayed side by side with an editing area or an independent (individual) window such as a pop-up window.

In addition, by a combination of the indicated matter extraction processing and the draft suggesting processing, the indicated matter and a draft candidate that can resolve the indicated matter may be proposed. At this time, the indicated matter and the draft candidate may be preferably displayed in association with an indicated portion of the document in position. For example, the indicated matter and the draft candidate may be preferably displayed close to a corresponding indicated matter. With such display, it is possible to compare the indicated matter, the draft candidate, and the corresponding portion of the document with less movement of a line of sight, and it is possible to reduce a load on a user.

In addition, for a document review area, a pop-up window, and the like in which the indicated matter and the draft candidate are displayed, folding display, minimization display, change in display size, and the like can be executed. As a result, a user can arrange a document display screen having a limited size such that the user can easily see the document display screen, for example, by aligning the document display screen with the indicated portion of the document. In addition, on the basis of the height of the indicated matter or the draft candidate, provisions may be displayed at a wider interval in an editing area. With such display, it is possible to more clearly and simply indicate a correspondence relationship among the indicated matter, the draft candidate, and the indicated portion of the document.

The difference information extraction processing of the present embodiment may present difference information between two pieces of document data, for example, the support target document data before correction and the corrected document data to a user. For example, the editing processing unit 115 of the present embodiment may extract difference information from the support target document data before correction and the corrected document data, and may present the difference information to a user in a predetermined display form, for example, by displaying the difference and the other portion (that is, the same portion) differently, for example, by emphasis display or highlighting.

The editing processing unit 115 of the present embodiment may execute the above-described various types of editing processing in response to an editing instruction received from the terminal device T1. In addition, the editing processing unit 115 of the present embodiment may convert a data format of the support target document data or the translation data in response to a storage instruction received from the terminal device T1 to generate document data to be a next version of the support target document. For example, in response to a download instruction or a storage instruction received from the terminal device T1, the editing processing unit 115 can generate document data in a “DOCX” format to be a next version of the support target document using support target document data in a “JSON” format.

The translation processing unit 116 of the present embodiment may translate a support target document in a first language and generate a support target document in a second language in display processing or document editing processing using a translation display function. In addition, the translation processing unit 116 may generate document review information in the second language in document review processing using the translation display function. In addition, the translation processing unit 116 may translate a corrected sentence created in the second language to generate a corrected sentence in the first language in document editing processing using the translation display function.

Furthermore, the translation processing unit 116 may translate an input candidate draft generated by the editing processing unit 115 into the first language or the second language in indicated matter extraction processing using the translation display function. In addition, the translation processing unit 116 may translate an indicated matter generated by the editing processing unit 115 into the first language or the second language in draft suggesting processing using the translation display function. In addition, the translation processing unit 116 may translate difference information generated by the editing processing unit 115 into the first language or the second language in difference information extraction processing using the translation display function.

Note that the translation processing executed by the translation processing unit 116 may be executed, for example, on the entire support target document, or may be executed on a part obtained by dividing the document, for example, a part of a unit such as a section, a paragraph, or an item.

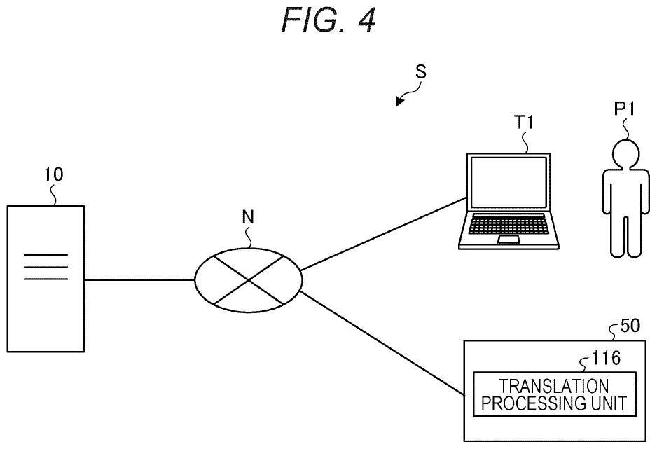

In the present embodiment, the case where the information processing device 10 includes the translation processing unit 116 has been exemplified. On the other hand, the translation processing unit 116 may use a translation processing unit achieved by an external device capable of communicating with the information processing device 10 via a network. For example, an online machine translation engine can be used as the translation processing unit achieved by the external device. This may make it possible to perform highly accurate translation with the information processing device 10 or a document browsing support function. In addition, as illustrated in FIG. 4, the translation processing unit 116 may be achieved by an external device 50 capable of communicating with the terminal device T1 via a network without intervention of the information processing device 10. In addition, the translation processing unit 116 may be in the terminal device T1.

The first control unit 117 of the present embodiment may perform information communication with the terminal device T1 via the network. Specifically, for example, the first control unit 117 may receive document data transmitted from the terminal device T1 and various instructions such as a document review instruction, an editing instruction, a translation instruction, a storage instruction, and an output instruction (for example, a download instruction). In addition, the first control unit 117 may transmit editing screen information (including information for executing editing processing on a terminal device T1 side) to the terminal device T1. The first control unit 117 may receive information including document data after editing processing from the terminal device T1.

The first control unit 117 of the present embodiment may generate layout information in the document editing processing. The layout information in the document editing processing may be, for example, information for displaying editing data in a predetermined form on a browser screen of the terminal device T1. In addition, the first control unit 117 of the present embodiment may generate layout information in the document review processing. The layout information in the document review processing may be, for example, information for displaying document review information generated by the document review processing and a support target document in a predetermined form on the browser screen of the terminal device T1. In addition, the first control unit 117 of the present embodiment may generate layout information in translation display processing. The layout information in the translation display processing may be, for example, information for displaying a translation generated by the translation display processing and a support target document in a predetermined form on the browser screen of the terminal device T1.

The layout information may associate the document review information (including translated information) generated by the document review processing and the support target document with each other in position. Note that the mutual association in position may refer to, for example, associating positions to be displayed so as to be browsed by a user, and specifically means associating the positions on a screen, for example, in units of articles, in units of paragraphs, or in units of sentences. Associating the positions may include, for example, displaying corresponding portions closer to each other in a height or width direction than the other portions, and more preferably, displaying the corresponding portions side by side on a screen. In addition, when additional information may be displayed together, the layout information may include information for associating the additional information with the document review information and the editing data in position.

The layout information may be generated by any method. For example, for a word or a phrase included in the document review information, the degree of coincidence may be scored for each position (for example, each position in units of articles or each position in units of paragraphs) in editing data by a search function, and the layout information may be generated such that the document review information is displayed corresponding to a position with the highest score. In addition, for example, by assigning coordinates in units of articles or in units of paragraphs of editing data and associating the coordinates with corresponding document review information, it is also possible to associate the display positions of the articles and the paragraphs with the display positions of the document review information.

The first control unit 117 of the present embodiment may transmit various types of information such as document review information generated by the analysis unit 113, editing data generated by the editing processing unit 115, translation data generated by the translation processing unit 116, and layout information generated by the first control unit 117 in response to a request from the terminal device T1.

The first storage unit 119 may store, for example, document data uploaded from the terminal device T1, document data of a new version generated from editing data by document editing processing, a support target document in a DOCX format, and additional information associated with each piece of document data.

In addition, the first storage unit 119 may store translation data generated by the translation processing unit 116 in association with, for example, the support target document.

### Terminal Device T1

The terminal device T1 of the present embodiment may transmit and receive information regarding document display and document editing to and from the information processing device 10 in a document browsing support service.

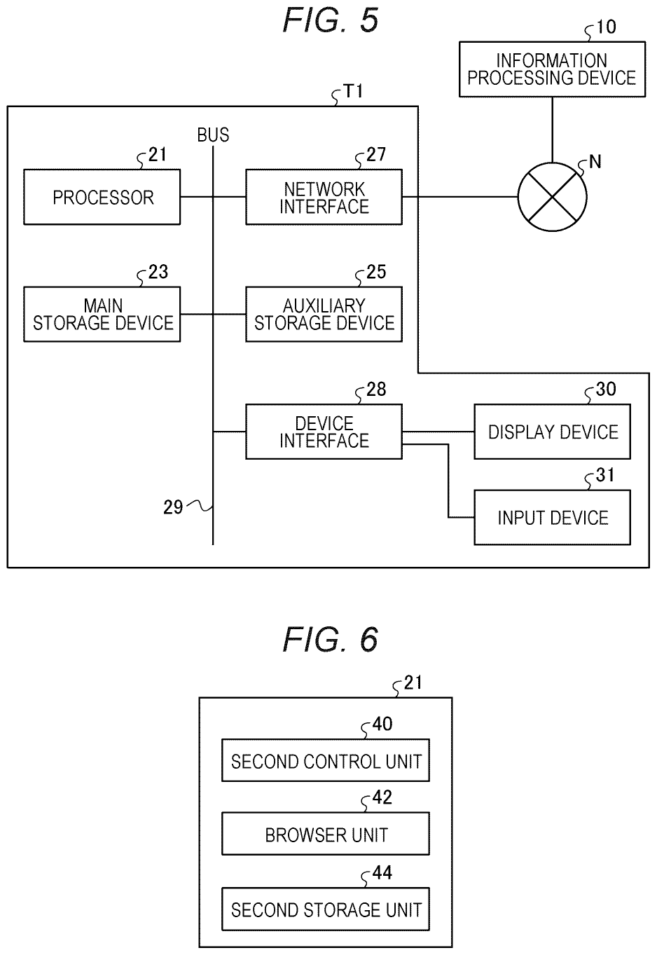

FIG. 5 is a block diagram illustrating an example of a hardware configuration of the terminal device T1 according to the embodiment. As illustrated in FIG. 5, the terminal device T1 may be a computer, and include, as an example, a processor 21, a main storage device (memory) 23, an auxiliary storage device (memory) 25, a network interface 27, a device interface 28, a bus 29 that connects the components to each other, a display device 30 connected to the device interface 28, and an input device 31 connected to the device interface 28. Note that specific hardware configurations of the processor 21, the main storage device 23, the auxiliary storage device 25, the network interface 27, the device interface 28, and the bus 29 are similar to those of the processor 11, the main storage device 13, the auxiliary storage device 15, the network interface 17, the device interface 18, and the bus 19, respectively, and therefore description thereof is omitted.

The display device 30 may be a display device such as a liquid crystal display (LCD), a cathode ray tube (CRT), a plasma display panel (PDP), or an organic electro luminescence (EL) panel. The display device 30 may display, for example, a document review screen and a document editing screen described later on the basis of an instruction from the processor 21.

The input device 31 may be a device such as a keyboard, a mouse, or a touch panel. A user can input various editing instructions, for example, in document editing processing described later using the input device 31. The instruction input from the input device 31 may be sent to the processor 21.

Note that the terminal device T1 may include another external device (for example, a camera, a microphone, a motion capture, or various sensors) connected via the device interface 28 in order to operate and edit document data.

FIG. 6 is a diagram illustrating an example of functional blocks in the processor 21. The processor 21 may include, for example, a second control unit 40, a browser unit 42, and a second storage unit 44 as functions implemented by the processor 21. Functions implemented by the second control unit 40, the browser unit 42, and the second storage unit 44 may be stored as programs in, for example, the main storage device 23 or the auxiliary storage device 25. By reading and executing a program stored in the main storage device 23, the auxiliary storage device 25, or the like, the processor 21 can implement functions related to the second control unit 40 and the browser unit 42.

For example, the second control unit 40 may activate the browser unit 42 in response to an instruction from a user.

The browser unit 42 may be, for example, a general web browser, and execute processing according to hyper text markup language (HTML) data, a script (for example, JavaScript (registered trademark)), or the like. When being activated, the browser unit 42 may transmit an initial access URL to the information processing device 10 to make access.

The browser unit 42 of the present embodiment may display data including text data and image data received from the information processing device 10 on the display device 30 of the terminal device T1 in a predetermined form. More specifically, in the document review processing, the browser unit 42 may display document review information, document data, additional information, and the like received from the information processing device 10 on the display device 30 of the terminal device T1 in a predetermined form on the basis of layout information. In addition, in the document editing processing, the browser unit 42 of the present embodiment may display, for example, document review information, editing data, and additional information received from the information processing device 10 on the display device 30 of the terminal device T1 in a predetermined form on the basis of layout information.

In addition, for example, the browser unit 42 may transmit a translation start instruction from a user to the information processing device 10. For example, the browser unit 42 may receive editing screen information (including information for executing editing processing) from the first control unit 117 of the information processing device 10, and execute editing processing or the like. For example, the browser unit 42 may receive a support target document that has been subjected to editing processing, and store the support target document in the second storage unit 44.

The second storage unit 44 may store, for example, support target document data before editing processing and support target document data after the editing processing in a DOCX format acquired by the browser unit 42. In addition, the second storage unit 44 can store translation data generated by the translation processing unit 116 in association with, for example, the support target document.

### Editing Processing Using Translation Display Function

Next, details of the translation display function implemented by the document browsing support system S will be described with reference to an example of GUI displayed on the display device 30 of the terminal device T1 when the function is used.

### Multi-Language Preview Support Function

A document translation display function, which is one of the translation display functions, may generate a support target document in Japanese (a translation document or a support target document in a second language) in response to a translation instruction from a user at an arbitrary timing when the user uploads a support target document in English (that is, an original document or a support target document in a first language) and a preview screen of the support target document in English is displayed, and displays the support target document in Japanese and the support target document in English side by side.

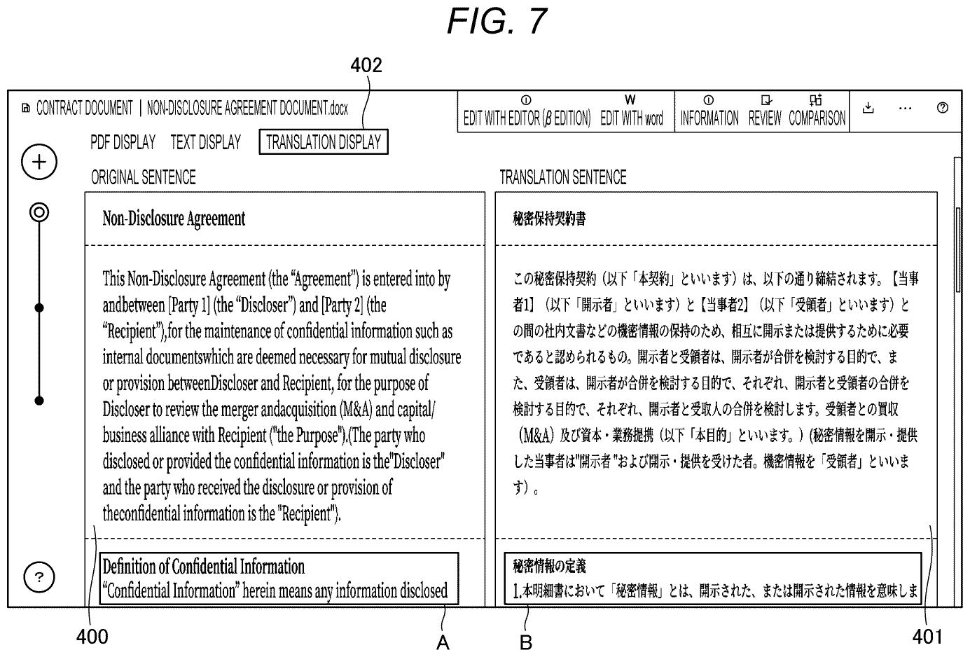

FIG. 7 is a diagram illustrating an example of a display screen displayed on the display device 30 of the terminal device T1 when a multi-language preview support function is executed. For example, on a preview screen before the multi-language preview support function is executed, only the support target document in the first language may be displayed. In this state, for example, when a user operates a translation display button 402, the translation processing unit 116 may execute translation processing on a support target document 400 in English, and a support target document 401 in Japanese that is the second language into which the support target document in the first language has been translated may be generated. As illustrated in FIG. 7, the support target document 400 in English and the support target document 401 in Japanese may be displayed in parallel on the display device 30 of the terminal device T1 according to layout information from the first control unit 117 such that, for example, the positions of articles correspond to each other. Note that the support target document 401 in the second language may be a text or document data that is a file like an uploaded support target document.

The user can grasp a content of the support target document 400 in English by comparing the support target document 400 in English and the support target document 401 in Japanese displayed in parallel as a function of an online editor. Therefore, it may not be necessary to use a machine translation tool that does not cooperate with the online editor in parallel, and a workload of the user can be reduced.

### Multi-Language Review Support Function

A multi-language display function, which is one of the translation display functions, will be described. The function may display a support target document in English, a review result obtained by executing review processing on the support target document in English, and a support target document in Japanese generated by translating the support target document in English side by side.

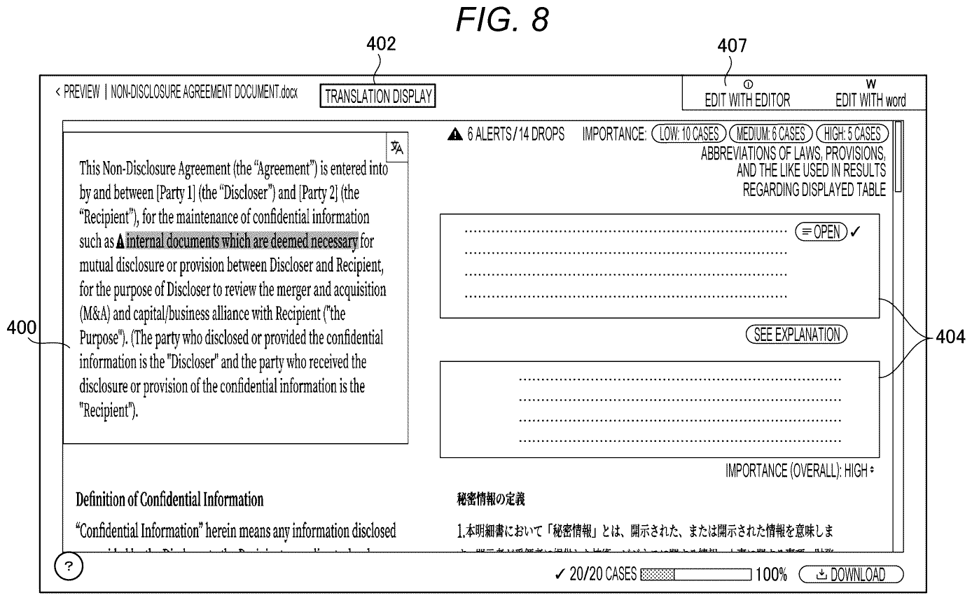

FIG. 8 is a diagram illustrating an example of the support target document 400 in English and a review result 404 displayed on the display device 30 of the terminal device T1 as a result of review processing. In the example illustrated in FIG. 8, the review result 404 may be associated with a corresponding position of the support target document 400 in English and displayed as Japanese. The review result 404 may be displayed in association with an article of a contract document that is the support target document, and can include analysis information of the article, in this example, contract review information such as “There is a risk that our company may be under excessive confidentiality obligations if a contract is concluded as set forth in this article. Please determine whether or not to be able to surely manage confidential information to be received by your department's line”.

In this example, the user can check, in Japanese, the review result 404 for the support target document in English together with the analysis information. Therefore, it is possible to facilitate understanding of the support target document. In addition, it is not necessary to use a machine translation tool that does not cooperate with the online editor in parallel, and a workload of the user can be reduced.

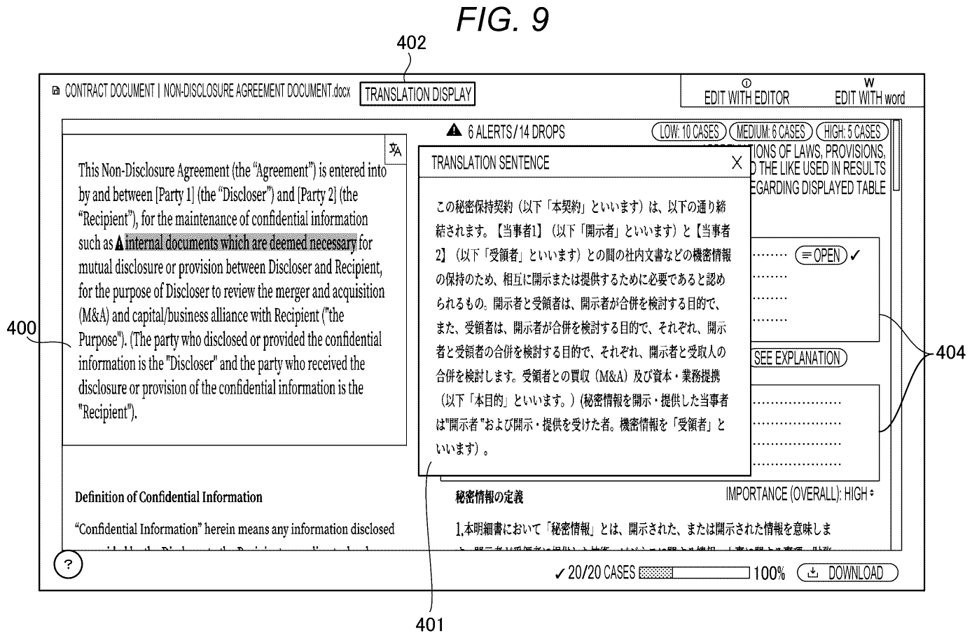

FIG. 9 is a diagram illustrating an example of a screen displayed on the display device 30 of the terminal device T1 when a multi-language review support function is executed. That is, when the user operates the translation display button 402 at an arbitrary timing on the screen illustrated in FIG. 8, the translation processing unit 116 may execute translation processing on the support target document 400 in English to generate the support target document 401 in Japanese. As illustrated in FIG. 9, in the present embodiment, the support target document 400 in English and the support target document 401 in Japanese may be displayed in parallel on the display device 30 of the terminal device T1 according to layout information from the first control unit 117 so as to be associated with each other in position, for example, such that the positions of articles correspond to each other side by side, specifically, such that one article of the original document and one article of the document in which the article is translated are aligned side by side.

Note that, in the screen illustrated in FIG. 9, for example, by moving a display position of the support target document 401 in Japanese by a drag and drop operation or by clicking an area of the review result, the review result can be displayed so as not to overlap with the original document or the support target document 401 in Japanese.

The user may select, for example, a review result including his or her own company risk from a plurality of review results and give a translation instruction to a desired provision of the support target document 400 in the first language (for example, English) corresponding to the review. In the present embodiment, by automatically displaying the second language translation (for example, Japanese translation) of the provision acquired by the translation instruction in parallel, the user can not only check a parallel translation of the provision of the support target document 400 in the first language, but also check a corresponding provision of the support target document 400 in the first language and the second language while understanding a content of the review result including his or her own company risk in the second language. Therefore, it is possible to largely reduce a workload when the user checks the support target document 400 in the first language. In addition, even if the support target document 401 in the second language includes a portion that is not accurately translated, it is possible to sufficiently grasp what kind of risk the foreign language contract document as the original document in the first language includes by referring to a content of the review result in the second language.

### Multi-Language Editing Support Function

An example of a multi-language editing support function, which is one of the translation display functions, will be described. This function may be used, for example, when draft suggesting processing, indicated matter extraction processing, difference information extraction processing, and editing processing (editing the support target document in the first language using Japanese (that is, the second language) or editing the support target document in the first language using English (that is, the first language)) are executed.

For example, in the draft suggesting processing, indicated matter extraction processing, and difference information extraction processing using the multi-language editing support function, a draft of an input candidate, an indicated matter, and difference information may be displayed in a predetermined form, for example, in English (that is, the first language), respectively. In addition, by changing setting, the draft of the input candidate, the indicated matter, and the difference information may be displayed in Japanese (that is, the second language), or may be displayed in English and Japanese.

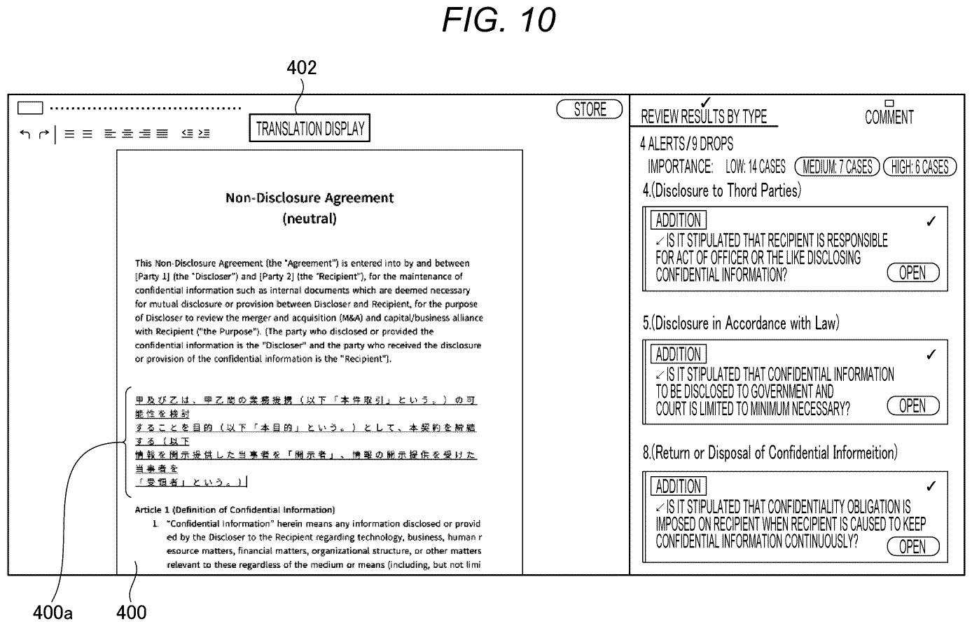

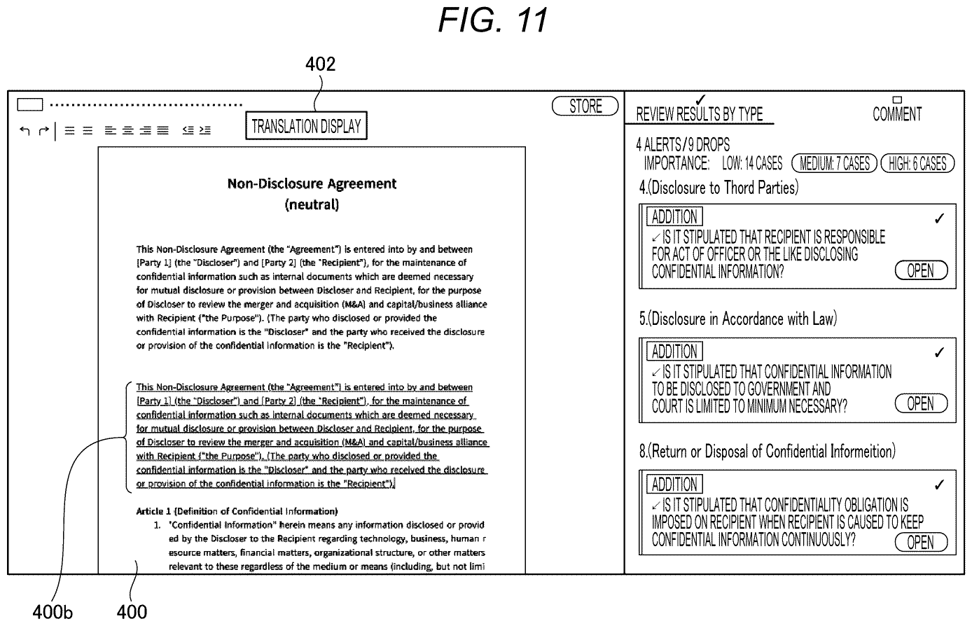

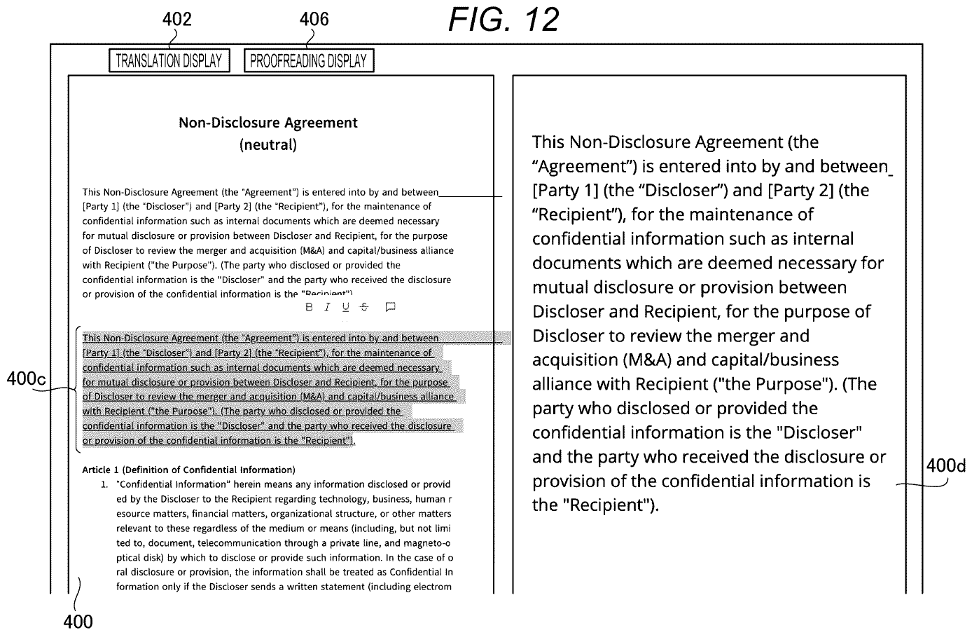

Each of FIGS. 10 and 11 is a diagram illustrating an example of a screen displayed on the display device 30 of the terminal device T1 when editing processing (processing of editing the support target document 400 in English using Japanese) is executed using the multi-language editing support function. First, in the screen illustrated in FIG. 10, it may be assumed that the user adds a correction proposal 400a in Japanese to the support target document 400 in English. In such a case, for example, when the translation display button 402 is operated, the translation processing unit 116 may translate the added correction proposal 400a in Japanese to generate a correction proposal 400b in English. On the display device 30 of the terminal device T1, as illustrated in FIG. 11, the correction proposal 400b in English may be displayed at a position corresponding to the correction proposal 400a in Japanese, for example, according to layout information from the first control unit 117.

The user can directly write the correction proposal 400a in Japanese in the support target document 400 in English, for example, on the basis of a content of the review result 404 including his or her own company risk, or the draft of the input candidate to be presented, the indicated matter, the difference information, or the like. In addition, the correction proposal 400a in Japanese can be translated into the correction proposal 400b in English using the multi-language editing support function. Furthermore, by executing review processing again on the support target document 400 in English including the correction proposal 400b in English, it is also possible to execute risk check or the like on the correction proposal 400b in English. Therefore, when the support target document 400 in English is corrected, a workload of the user can be largely reduced.

Some users may wish to directly perform editing processing in English (instead of Japanese) on the support target document 400 in English. Even in such a case, the multi-language editing support function can be used.

FIG. 12 is a diagram illustrating an example of a screen displayed on the display device 30 of the terminal device T1 when editing processing (processing of editing the support target document 400 in English using English) is executed using the multi-language editing support function. In FIG. 12, it may be assumed that a user directly adds a correction proposal 400c in English to the support target document 400 in English. In such a case, when a proofreading display button 406 is operated, the translation processing unit 116 may perform proofreading processing on the correction proposal 400c in English to generate a proofread correction proposal 400d in English. On the display device 30 of the terminal device T1, as illustrated in FIG. 12, the proofread correction proposal 400d in English may be displayed in parallel with the correction proposal 400c according to layout information from the first control unit 117.

If necessary, the user can directly write the correction proposal 400c in English in the support target document 400 in English on the basis of a content of the displayed review result 404, or the draft of the input candidate to be presented, the indicated matter, analysis information such as the difference information, or the like. In addition, by creating the correction proposal 400c in English and executing proofreading processing using the multi-language editing support function, the user can automatically acquire the English proofread correction proposal 400d satisfying a format as a contract document (or a legal document). Therefore, when the support target document 400 in English is corrected, a workload of the user can be largely reduced.

In addition, it is possible to output the support target document 400 in English and the support target document 401 in Japanese in association with each other, for example, for each article using the multi-language editing support function.

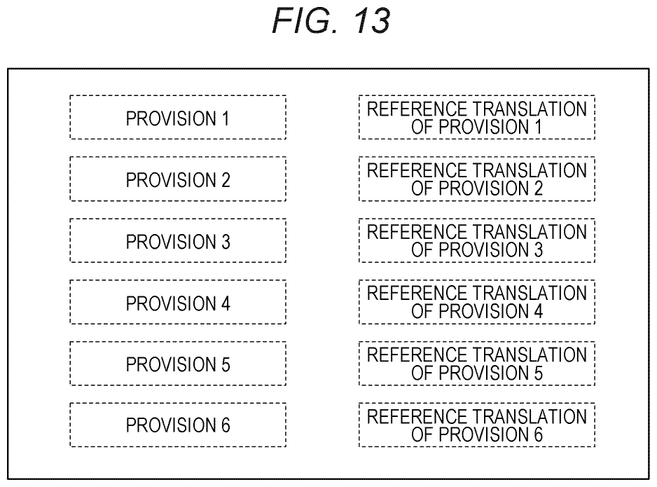

FIG. 13 is a diagram illustrating an example of output data which is generated by the multi-language editing support function and in which the support target document 400 in English and the support target document 401 in Japanese are associated with each other for each article. As illustrated in FIG. 13, the output data may be generated in a format in which each article (each provision in the example of FIG. 13) of a reference translation constituting the support target document 401 in Japanese is associated with each provision such as provision 1 or provision 2 constituting the support target document 400 in English. In addition, the output data may be, for example, tabular data in which a first article of the original document and a translation thereof are generated in adjacent cells.

### Flow of Editing Processing Using Translation Display Function

Next, an example of editing processing using the translation display function implemented by the present embodiment will be described.

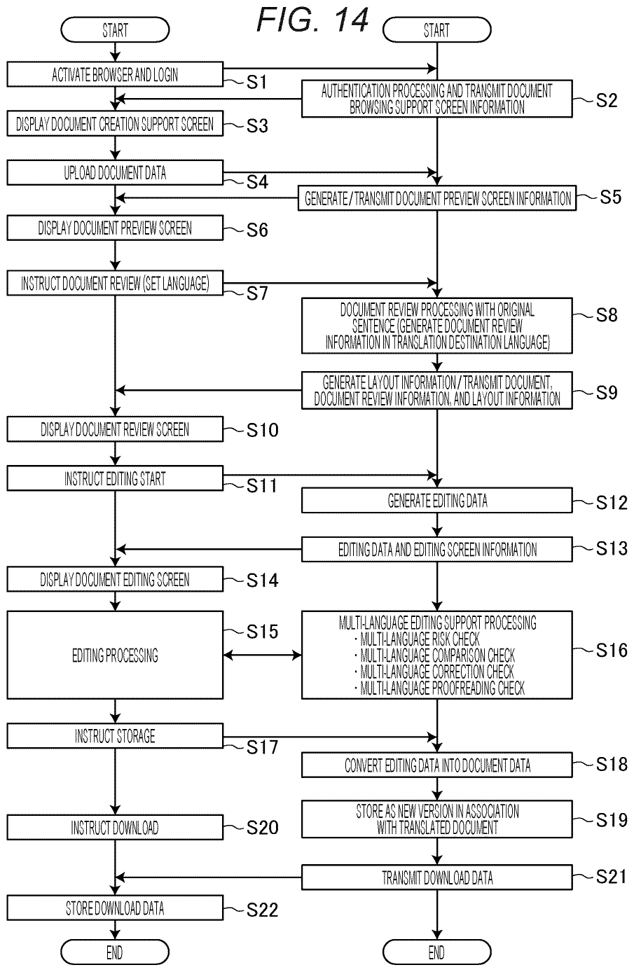

FIG. 14 is a flowchart illustrating a flow of editing processing using the translation display function according to the present embodiment. First, the second control unit 40 of the terminal device T1 may activate the browser unit 42 in response to an instruction from a user. The browser unit 42 of the terminal device T1 may transmit, for example, login information such as an initial access URL or a registration ID to the information processing device 10 (step S1).

For example, the first control unit 117 of the information processing device 10 may execute authentication processing in response to the login information from the terminal device T1. In addition, the first control unit 117 may transmit, for example, document browsing support screen information generated by the first control unit 117 (step S2).

For example, the browser unit 42 of the terminal device T1 may display a document browsing support screen on the display device 30 on the basis of the document browsing support screen information received from the information processing device 10 (step S3).

For example, the browser unit 42 of the terminal device T1 may transmit support target document data to the information processing device 10 in response to a document upload instruction from the user (step S4). Note that this upload instruction may be performed by a user who gives a review instruction, or may be performed by a different user or/and a terminal. For example, the upload instruction may be performed by a terminal of a user of another department that requests a legal department to examine a contract document.

The acquisition unit 111 of the information processing device 10 may store, for example, document data acquired (received) from the terminal device T1 in the first storage unit 119. For example, the first control unit 117 of the information processing device 10 may generate document preview screen information on the basis of the document data acquired by the acquisition unit 111. For example, the first control unit 117 of the information processing device 10 may transmit the generated document preview screen information to the terminal device T1 (step S5). Note that the document upload instruction and the storage of the document data in the first storage unit 119 may be performed, for example, by another user and/or another terminal of another department that requests a legal department to examine a contract document prior to editing processing.

In addition, for example, the first control unit 117 may preferably determine a language (first language) of the document data acquired by the acquisition unit 111 (that is, the uploaded support target document data). Note that, in the present embodiment, the first language may be determined to be English. In addition, this language determination may be performed by a user.

For example, the browser unit 42 of the terminal device T1 may display a document preview screen on the basis of the document preview screen information received from the information processing device 10 (step S6). Note that, at this stage, since document review processing has not been performed, for example, only the support target document may be displayed on the document preview screen. By executing this step S6, the document browsing support system S of the present embodiment can be used not only for editing a document but also for browsing a document.

Furthermore, on the document preview screen of the support target document in English in step S6, for example, by operating selection of the second language (Japanese in the present embodiment) and a translation display button, the support target document in Japanese can be displayed side by side together with the support target document in English by the translation display function.

The browser unit 42 of the terminal device T1 may transmit, for example, an editing start instruction input from the user to the information processing device 10 (step S7). At this time, the browser unit 42 of the terminal device T1 may transmit, for example, information specifying the second language set in advance or selected on the basis of a selection operation or the like from the user to the information processing device 10.

In response to a document review instruction from the terminal device T1, the analysis unit 113 of the information processing device 10 may perform document review processing on the support target document in English (original sentence/first language) to generate document review information in Japanese (second language) (step S8). Note that the document review information not only generates review information in the second language for the support target document in the first language as described above, but also can generate review information in which the review information in the first language set for a support document in the first language is translated by setting. In addition, the document review information can generate review information in the second language for a support document in the second language in which the support document in the first language is translated.

The first control unit 117 of the information processing device 10 may generate layout information for displaying the document review information in Japanese in association with the support target document. The first control unit 107 of the information processing device 10 may transmit the support target document data in English, the document review information in Japanese, and the layout information generated by the first control unit 107 to the terminal device T1 (step S9).

The browser unit 42 of the terminal device T1 may display a document review screen on the basis of the support target document data in English, the document review information in Japanese, and the layout information received from the information processing device 10 (step S10). Note that, on this document review screen, for example, the support target document data in English and the document review information in Japanese as illustrated in FIG. 8 are displayed in a form in which positions thereof may be associated with each other.

For example, the browser unit 42 of the terminal device T1 may transmit an editing start instruction (for example, an instruction by operation of the button 407 illustrated in FIG. 8) input from the user to the information processing device 10 (step S11).

The editing processing unit 115 of the information processing device 10 may convert the data format of the document data into, for example, a JSON format, for example, in response to the editing start instruction from the terminal device T1 to generate editing data (step S12).

The first control unit 117 of the information processing device 10 may transmit, for example, the generated editing data and editing screen information (including information for executing editing processing using the translation display function) to the terminal device T1 (step S13).

The browser unit 42 of the terminal device T1 may display a document editing screen on the basis of the editing data and the editing screen information received from the information processing device 10 (step S14).

The browser unit 42 of the terminal device T1 may execute editing processing, for example, in response to an editing operation from the user (step S15). In addition, when executing the editing processing using the translation display function, the browser unit 42 of the terminal device T1 may transmit document data to be translated and proofread to the information processing device 10.

The editing processing unit 115 and the translation processing unit 116 of the information processing device 10 may perform multi-language document browsing support processing including translation processing, proofreading processing, and the like, for example, using the document data to be translated and proofread, received from the browser unit 42 of the terminal device T1 (step S16). The first control unit 117 of the information processing device 10 may transmit various kinds of translation data generated by the multi-language document browsing support processing to the terminal device T1.

Note that the processing in steps S15 and S16 may be repeatedly executed until the user determines an editing content.

In response to a storage instruction input from the user, the browser unit 42 of the terminal device T1 may transmit the storage instruction to the information processing device 10 (step S17).

For example, in response to the storage instruction from the terminal device T1, the editing processing unit 115 of the information processing device 10 may convert the data format of the editing data reflecting editing from the JSON format to a DOCX format to generate support target document data in the DOCX format (step S18).

In addition, the editing processing unit 115 of the information processing device 10 may store, for example, the generated support target document data in the DOCX format in the first storage unit 119 as document data for storage of a new version in association with the support target document in Japanese as a translation (step S19).

Note that, in step S19, for example, the edited support target document data in the DOCX format may be overwritten on the support target document data in the DOCX format uploaded in step S4. In addition, the support target document data in the DOCX format uploaded in step S4 and the edited support target document data in the DOCX format can be stored as separate pieces of data (for example, pieces of data of different versions or pieces of data of successive versions).

For example, in response to an operation of a download button input from the user, the browser unit 42 of the terminal device T1 may transmit, to the information processing device 10, a download instruction of support target document data in the DOCX format, translated support target document data, data including a support target document in English and a support target document in Japanese, particularly output data including a parallel translation in which a support target document in English and a support target document in Japanese may be associated with each other for each article, or the like (step S20). Note that the output data including the translated support target document may preferably include a caution display indicating that the second support target document is, for example, a reference translation using machine translation, points of attention about handling, and the like. As a result, the user can more appropriately use the translated support target document.

This download instruction can be arbitrarily performed without being limited to after step S19.

The first control unit 117 of the information processing device 10 may transmit, for example, edited support target document data in the DOCX format and the like to the terminal device T1 (step S21).

The browser unit 42 of the terminal device T1 may receive, for example, the edited support target document data in the DOCX format received from the information processing device 10, and store the edited support target document data in the second storage unit 44 (step S22).

Note that the browser unit 42 may issue a URL that can access the edited document data without performing download processing on the document data. In addition, the terminal device that performs download may be a terminal device different from the terminal device that has performed editing, and the download may be performed by a user of another department that requests a legal department to examine a contract document or a contract negotiation partner.

The information processing device 10 according to the present embodiment may include the main storage device 13 and the auxiliary storage device 15 as at least one memory, and the processor 11 as at least one processor. The processor 11 may simultaneously display the support target document 400 that is first document data including a sentence in a first language (for example, English), the support target document 401 that is a translation of the support target document 400 and is second document data including a sentence in a second language (for example, Japanese) different from the first language, and the review result 404 that is risk information data indicating a risk included in the support target document 400 in English on a screen of a display device.

In addition, the processor 11 may simultaneously display the support target document 400 in English, the support target document 401 in Japanese, and the review result 404 that is Japanese risk information data indicating a risk included in the support target document 400 in English on the screen of the display device.

Therefore, the user not only can check a parallel translation of a provision of the support target document 400 in English but also can check English and Japanese of a corresponding provision of the support target document 400 while understanding a content of a review result including his or her own company risk. Therefore, it is possible to largely reduce a workload when the user checks the support target document 400 in English. In addition, even if the support target document 401 in Japanese includes a portion that is not accurately translated, the user can sufficiently grasp what kind of risk the foreign language contract document as the original document includes by referring to a content of the review result.

As a result, it is possible to provide a document browsing support technique that is more efficient and less burdensome than before when a document in a foreign language is created.

In addition, it is not necessary to use a machine translation tool that does not cooperate with a tool for displaying and editing a foreign language contract document as the original document in parallel, and a workload of the user can be reduced. In addition, as compared with a case of checking a Japanese contract document obtained by a machine translation tool, for example, even when the Japanese contract document includes a portion that is not accurately translated, the user can sufficiently grasp what kind of risk the foreign language contract document as the original document includes.

### Modification 1

A table or the like may be included in the support target document 400 in English. In such a case, the information processing device 10 may generate editing data excluding the table or the like in step S12 and executes editing processing. An English portion included in the excluded table or the like may be translated by the translation processing unit 116 and combined with edited editing data when document data for storage is generated in step S17. Therefore, a layout of the translation portion of the table or the like included in the support target document 400 in English may not be changed by the editing processing. As a result, it is possible to maintain a layout of the table or the like of the support target document in English in storage data or download data.

### Modification 2

Some or all of the devices in the above-described embodiment may be configured by hardware, or may be configured by information processing of software (program) executed by a CPU, a GPU, or the like. In addition, in the above embodiment, when a plurality of storage devices stores data, each of the plurality of storage devices may store only a part of the data or may store the entire data.

An information processing program according to an embodiment may cause a computer to implement a function of simultaneously displaying first document data including a sentence in a first language, second document data that is a translation of the first document data and includes a sentence in a second language different from the first language, and risk information data that indicates a risk included in the first document data on a screen of a display device.

An information processing program according to an embodiment may cause a computer to implement a function of simultaneously displaying first document data including a sentence in a first language, second document data that is a translation of the first document data and include a sentence in a second language different from the first language, and risk information data including a first language sentence that indicates a risk included in the first document data on a screen of a display device.

An information processing method according to an embodiment may includes: acquiring first document data including a sentence in a first language, and second document data that is a translation of the first document data and includes a sentence in a second language different from the first language; generating risk information data that indicates a risk included in the first document data; and simultaneously displaying the first document data, the second document data, and risk information data on a screen of a display device.

An information processing method according to an embodiment may include: acquiring first document data including a sentence in a first language, and second document data that is a translation of the first document data and includes a sentence in a second language different from the first language; generating risk information data including a first language sentence that indicates a risk included in the first document data; and simultaneously displaying the first document data, the second document data, and risk information data on a screen of a display device.

Although the embodiments of the present disclosure have been described in detail above, these embodiments have been presented as examples, and are not intended to be limited to individual embodiments. The embodiments can be modified by various additions, changes, replacements, partial deletions, combinations, and the like without departing from the technical idea of the present invention. These embodiments and modifications thereof are included in the invention described in the claims and an equivalent scope thereof.

What is claimed is:

1. An information processing method comprising:
acquiring first document data including a sentence in a first language, and second document data that is a translation of the first document data and includes a sentence in a second language different from the first language;
generating risk information data that indicates a risk included in the first document data; and
simultaneously displaying the first document data, the second document data, and analysis information of the first document data on a screen of a display device.

2. The information processing method according to claim 1, wherein
the analysis information is a sentence in the second language.

3. The information processing method according to claim 1, wherein
the first document data is a legal document, and the analysis information is a legal risk included in the first document data.

4. The information processing method according to claim 2, wherein
the first document data is a legal document, and the analysis information is a legal risk included in the first document data.

5. The information processing method according to claim 1, further comprising
displaying, on the screen, at least one of a draft proposed in editing the first document data, an indicated matter, and difference information from a reference document.

6. The information processing method according to claim 2, further comprising
displaying, on the screen, at least one of a draft proposed in editing the first document data, an indicated matter, and difference information from a reference document.

7. The information processing method according to claim 1, further comprising
providing a correction proposal in the second language as a correction proposal in the first language to the first document data.

8. The information processing method according to claim 2, further comprising
providing a correction proposal in the second language as a correction proposal in the first language to the first document data.

9. The information processing method according to claim 1, further comprising
executing proofreading processing on the correction proposal in the first language inserted into the first document data and simultaneously displaying the correction proposal on the screen.

10. The information processing method according to claim 2, further comprising
executing proofreading processing on the correction proposal in the first language inserted into the first document data and simultaneously displaying the correction proposal on the screen.

11. The information processing method according to claim 1, further comprising
simultaneously displaying the first document data, the second document data, and the risk information data on the screen in association with each other for each provision.

12. The information processing method according to claim 2, further comprising
simultaneously displaying the first document data, the second document data, and the risk information data on the screen in association with each other for each provision.

13. The information processing method according to claim 1, further comprising
generating and outputting output data associated with the first document data and the second document data for each unit of a predetermined sentence.

14. The information processing method according to claim 2, further comprising
generating and outputting output data associated with the first document data and the second document data for each unit of a predetermined sentence.

15. The information processing method according to claim 1, further comprising
associating the first document data and the second document data with each other and storing the first document data and the second document data in a storage unit for each version of the first document data.

16. The information processing method according to claim 2, further comprising
associating the first document data and the second document data with each other and storing the first document data and the second document data in a storage unit for each version of the first document data.

17. An information processing device comprising
at least one processor, wherein
the at least one processor
simultaneously displays first document data including a sentence in a first language, second document data that is a translation of the first document data and includes a sentence in a second language different from the first language, and analysis information of the first document data on a screen of a display device.

18. A non-transitory computer-readable medium storing instructions that, when executed by one or more processors, cause the one or more processors to perform operations comprising:
acquiring first document data including a sentence in a first language, and second document data that is a translation of the first document data and includes a sentence in a second language different from the first language;
generating risk information data that indicates a risk included in the first document data; and
simultaneously displaying the first document data, the second document data, and analysis information of the first document data on a screen of a display device.
